(19) United States
(12) Patent Application Publication
(10) Pub. No.: US 2025/0162866 A1
(43) Pub. Date: May 22, 2025

(54) METHOD FOR CRACKING AMMONIA

(71) Applicant: L'Air Liquide, Societe Anonyme pour l'Etude et l’Exploitation des Procedes Georges Claude, Paris (FR)

(72) Inventors: Teja SCHMID MCGUINNESS, Frankfurt am Main (DE); Umberto ROSSI, Frankfurt am Main (DE); Florian PONTZEN, Frankfurt am Main (DE); Dominik SCHACK, Frankfurt am Main (DE)

(73) Assignee: L'Air Liquide, Societe Anonyme pour l'Etude et l’Exploitation des Procedes Georges Claude, Paris (FR)

(21) Appl. No.: 18/723,384

(22) PCT Filed: Dec. 19, 2022
(86) PCT No.: PCT/EP2022/086703

§ 371 Date: Jun. 21, 2024

(30) Foreign Application Priority Data
Dec. 21, 2021 (EP) EP 21216272.1

(51) Int. Cl. C01B 3/04

(52) U.S. Cl. CPC C01B 3/047; C01B 2203/0277; C01B 2203/04; C01B 2203/0833; C01B 2203/0883; C01B 2203/1052; C01B 2203/1064

(57) ABSTRACT

A method for producing hydrogen using a feed stream comprising ammonia is provided. The method can include the steps of: heating the feed stream in a first heat exchanger to produce a heated feed stream, wherein the heated feed stream is at a temperature above 500° C.; introducing the heated feed stream into a first reaction zone under conditions effective for catalytically cracking the heated feed stream to produce a raw hydrogen stream, wherein the raw hydrogen stream comprises hydrogen and nitrogen; cooling the raw hydrogen stream by indirect heat exchange against a first cooling fluid to form a cooled hydrogen stream; and purifying the raw hydrogen stream to produce a hydrogen product stream and a tail gas, wherein the tail gas has a higher concentration of nitrogen as compared to the hydrogen product stream.

### CROSS REFERENCE TO RELATED APPLICATIONS

This application is a § 371 of International PCT Application PCT/EP2022/086703, filed Dec. 19, 2022, which claims the benefit of EP21216272.1, filed Dec. 21, 2021, both of which are herein incorporated by reference in their entireties.

### TECHNICAL FIELD OF THE INVENTION

The present invention relates to a method for hydrogen production using non-hydrocarbon feedstocks. More specifically, embodiments of the present invention are related to using ammonia as a feedstock to a hydrogen production facility in lieu of hydrocarbons, particularly natural gas.

### BACKGROUND OF THE INVENTION

In an effort to reduce the effects of carbon dioxide emissions, new energy carriers are becoming increasingly important. One of the leading energy carriers is hydrogen; however, due to its small molecular size, high pressure requirements, and very low boiling point, transportation of elemental hydrogen is difficult and costly.

Ammonia (NH₃) has raised some attention in the literature, since existing infrastructure can be used for storage and transportation (e.g., LPG infrastructure). As such, production of hydrogen using ammonia, instead of natural gas, is foreseen to play a major role in the future of hydrogen as a key molecule in the low carbon energy transition.

Various NH₃ cracking concepts have been proposed so far, often involving one or more of the following disadvantages:
the cracking is conducted at low pressure, with the consequence that the hydrogen is obtained at low pressure. Hydrogen cannot, however, be compressed in centrifugal compressors, owing to its low molecular weight, and must instead be compressed in less efficient, less reliable and more costly piston-type or membrane-type compressors;
most low-pressure processes have a limited scalability and therefore are not suitable for world scale hydrogen production. For large scale production (i.e., typically 200 tpd or 100,000 Nm3/h H₂), the ammonia consumption must be limited as far as possible;
a recycle loop is required around the cracker, leading to extra equipment and costs; otherwise, the ammonia consumption is much higher than the theoretical minimum;
it can be a challenge to devise an efficient heat integration scheme in which no steam is produced because, unlike the steam methane reforming process, where steam generation is an integral part of the overall heat integration and rapid cooling by water is required to protect the materials from metal dusting corrosion, ammonia cracking does not require any steam to be produced.

Therefore, it would be advantageous to provide a solution that can allow for efficient production of hydrogen from an ammonia feed gas without suffering from the aforementioned disadvantages.

### SUMMARY OF THE INVENTION

The present invention is directed to an apparatus and process that satisfies at least one of these needs. In certain embodiments of the invention, an ammonia feed gas can be cracked at a sufficiently high pressure such that no hydrogen compression means are required downstream of the ammonia cracker. In another embodiment, the ammonia to hydrogen conversion can be conducted without a recycle loop. In yet another embodiment, the process does not require use of a steam system for its heat integration.

A method for producing hydrogen using a feed stream comprising ammonia is provided. The method can include the steps of: heating the feed stream in a first heat exchanger to produce a heated feed stream, wherein the heated feed stream is at a temperature above 500° C.; introducing the heated feed stream into a first reaction zone under conditions effective for catalytically cracking the heated feed stream to produce a raw hydrogen stream, wherein the raw hydrogen stream comprises hydrogen and nitrogen; cooling the raw hydrogen stream by indirect heat exchange against a first cooling fluid to form a cooled hydrogen stream; and purifying the raw hydrogen stream to produce a hydrogen product stream and a tail gas, wherein the tail gas has a higher concentration of nitrogen as compared to the hydrogen product stream.

In optional embodiments of the method of the invention:
the first reaction zone comprises reaction tubes filled with catalyst, wherein the catalyst are preferably selected from the group consisting of nickel, cobalt, ruthenium, rhodium, and combinations thereof;
the raw hydrogen stream is at a temperature of at least 550° C. after leaving the first reaction zone;
the feed stream is heated by indirect heat exchanger in the first heat exchanger against a second cooling fluid, wherein the second cooling fluid is the raw hydrogen stream;
the conditions effective for catalytically cracking the heated feed stream comprise a pressure between 20 and 35 bar (a) and providing heat to the first reaction zone via combustion burners that are fed with a fuel in the presence of an oxidizer, wherein the fuel comprises ammonia;
The method can also include the step of providing a second reaction zone in parallel with the first reaction zone, wherein the second reaction zone comprises a gas heated cracker that is heated by the flue gas;
the second reaction zone is fed with a portion of the heated feed stream, wherein the portion is between 5% and 35% of the heated feed stream;
the fuel has a lower heating value (LHV), wherein between 15-50% of the LHV is provided by ammonia, wherein between 50-85% of the LHV is provided by hydrogen;
the tail gas, which is comprised of nitrogen, hydrogen, and unreacted ammonia, is fed with the fuel to the combustion burners, wherein a flue gas is produced by the combustion burners, the flue gas being substantially free of carbon dioxide, wherein the flue gas is preferably used to provide heating to a cold stream selected from the group consisting of the feed stream, the heated feed stream, water, the oxidizer, and combinations thereof;
the raw hydrogen stream has a first hydrogen-component molar flow rate, and the hydrogen product stream has a second hydrogen-component molar flow rate, wherein a ratio of the second hydrogen-component molar flow rate to the first H₂-component molar flow rate (ηH₂) is in the range of 0.70 to 0.90;
the first cooling fluid is water and an export steam stream is produced by said indirect heat exchange during the step of cooling the raw hydrogen stream, wherein the export steam stream flow rate compared to the second flow rate is preferably below 0.25 kg steam/Nm³ H₂;
the heated feed stream is catalytically cracked in the presence of steam, wherein the steam is in an amount effective to reduce the formation of nitrides; and/or
the H₂ product forms a first mass flow rate, and a sum of the ammonia streams used for the feedstock and fuel form a second mass flow rate, wherein a ratio of the first mass flow rate to the second mass flow rate is at least 0.132.

### BRIEF DESCRIPTION OF THE DRAWINGS

These and other features, aspects, and advantages of the present invention will become better understood with regard to the following description, claims, and accompanying drawings. It is to be noted, however, that the drawings illustrate only several embodiments of the invention and are therefore not to be considered limiting of the invention's scope as it can admit to other equally effective embodiments.

FIG. 1 shows an embodiment of a hydrogen production facility using ammonia as the feedstock in accordance with an embodiment of the prior art.

FIG. 2 shows an embodiment of a hydrogen production facility using ammonia as the feedstock and fuel with improved heat integration in accordance with an embodiment of the present invention.

FIG. 3 shows another embodiment of a hydrogen production facility using ammonia as the feedstock and fuel where the heat integration is improved such that no steam system is required in accordance with an embodiment of the present invention.

FIG. 4 shows another embodiment of a hydrogen production facility using ammonia as the feedstock and fuel, in which a gas heated cracker is added in parallel to the main cracker, and where the heat integration is improved such that no steam system is required, in accordance with an embodiment of the present invention.

### DETAILED DESCRIPTION

While the invention will be described in connection with several embodiments, it will be understood that it is not intended to limit the invention to those embodiments. On the contrary, it is intended to cover all the alternatives, modifications and equivalence as may be included within the spirit and scope of the invention defined by the appended claims.

In reference to the Figures, unless otherwise noted, dotted and dashed lines between two pieces of equipment are meant to indicate that the equipment is, at a minimum, thermally integrated.

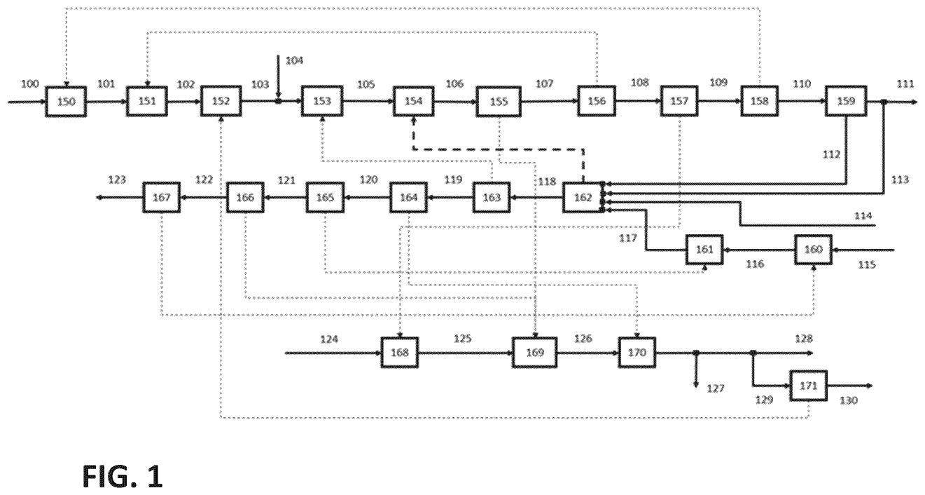

A reference case is provided, Case 1a, based on the cracking of NH₃ in an existing SMR at a cracking T of 600° C. This reference case is described in FIG. 1. The process NH₃ 100 is vaporized and pre-heated in successive heat exchangers 150, 151, and 152. As an option, a small amount of steam 104/127 can be mixed with the NH₃ (such that the steam preferably accounts for less than 1% mol of the mixture) to protect against the risk of formation of unwanted nitrides. The heated process NH₃ is then preferentially heated to a T in excess of 500° C. in 153, before being sent to the reactor 154, where it is cracked in catalyst-filled tubes at an outlet cracking T of at least 550° C. The heat of the raw H₂ 106 is then successively used to vaporize water to produce steam in the process gas boiler 155/169, to vaporize the NH₃ feedstock in 156/151, to heat the boiler feed water in 157/168, and for further vaporization of the NH₃ feedstock in 158/150. The raw H2 stream 110 enters the PSA 159 at a T of ˜40° C., from which an H₂ stream with high purity (preferably at least 99.9%) 111 is recovered.

The PSA off-gas 112, which includes N₂, H₂, as well as unreacted NH₃ is sent to the burners of the reformer furnace 162, where it is mixed and combusted with NH₃ fuel 114, and hot combustion air 117. In this case approximately 48% of the LHV is provided by NH₃ and approximately 52% by H₂. The combustion of this mixture is simple due to the sufficiently high flame speed. As an option, a portion of the H₂ product can be used as fuel 113 to offset part of the NH₃ fuel consumption. Part of the heat generated in the furnace is used in the endothermic cracking reaction in 154. The remaining heat in the flue gas 118 is then successively used to heat the reformer feed in 163/153, superheat steam in 164/170, heat the combustion air in 165/161, generate steam in the flue gas boiler 166/169, and pre-heat the combustion air in 167/160. In this cracker, we consider a common steam system for the process gas and flue gas. The boiler feed water 124 is pre-heated by raw H₂ in 168, vaporized in the boiler 169 by the process gas 106 and flue gas 121, and superheated in 170 by the flue gas 119. Part of the steam production is sent to heat exchanger 171/152, to vaporize and pre-heat the NH₃ feedstock further. The rest of the steam production is exported as a co-product 128.

Alternatively, the optional H₂ flow rate used as fuel 113 could instead have been taken upstream of the PSA 159, or the PSA could have been designed with a lower H₂ recovery, such that the required quantity of H₂ for fuel is contained in the PSA off-gas 112. To account for the alternatives where the H₂ contribution to the fuel is provided upstream of the PSA, or through the PSA off-gas, we also include an “H2 fuel ratio” in Table 1, ηH2f, defined as follows:

$$η H 2 = \frac{H 2 mole flow rate product to customer ( kmol \frac{H 2}{h} )}{H 2 mole flow rate at cracker outlet ( kmol \frac{H 2}{h} )} \qquad ( 1 )$$

$$ηH2 f = \frac{sum of all H 2 mole flow rates to fuel ( kmol \frac{H 2}{h} )}{H 2 mole flow rate at cracker outlet ( kmol \frac{H 2}{h} )} = 1 - ηH2 \qquad ( 2 )$$

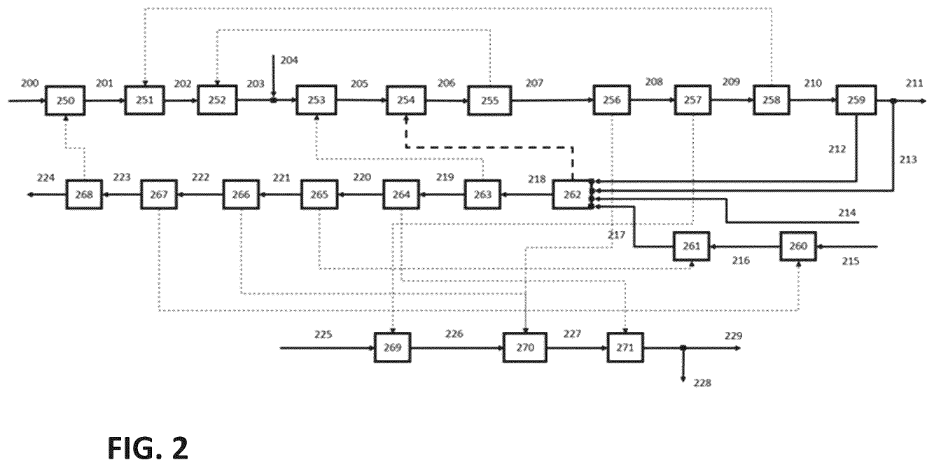

Case 1b, which is described in FIG. 2, is a greenfield NH₃ cracker in which the setup strays from the typical SMR heat integration. The refrigerated NH₃ feedstock 200 is vaporized/pre-heated in a series of 3 heat exchangers 250, 251, and 252. Here also, a small amount of steam 204/228 can be mixed with the NH₃ to protect against the risk of nitridation. The NH₃ feedstock 203 is then heated to a T in excess of 500° C., before being cracked in the reactor 254. The heat integration is now different from the SMR setup described in Case 1a, with the heat of the reacted process gas 206 being used first to preheat the NH₃ feedstock 202 in 255/252, and then to generate steam 227 in the process gas boiler 256/270. The reverse is also possible, with generation of steam first, follow by pre-heating of the NH₃ feedstock. The raw H₂ 208 is then cooled in the boiler feed water pre-heater 257/269, and it 209 is also further cooled in the feedstock vaporizer 258/251, before being sent to the PSA 259, from which we recover the pure H₂ stream 211, and an optional pure H₂ stream 213 is routed to the burners of the furnace 262. The PSA off-gas 212 is mixed with NH₃ fuel 214 and combustion air 215/216/217, and combusted in the furnace. In this case, approximately 43% of the LHV is represented by NH₃ and approximately 57% by H₂. Part of the heat generated in the furnace is used to drive the cracking reaction in the catalyst filled tubes 254, and the rest of the heat exchangers on the flue gas are arranged exactly as in the SMR in Case 1a, with the exception of the addition of the heat exchanger 268/250, where the low grade heat available at the flue gas outlet is used to vaporize the NH₃ feedstock. Given the similar temperature levels of the raw H₂ 209 and flue gas 223, the heat exchangers/NH₃ vaporizers 258/251 and 268/250 could be combined into a single piece of equipment.

Compared to Case 1a, the overall NH₃ consumption is decreased by 2.5% in Case 1b, and the steam export is reduced by 3.9 t/h (˜14%).

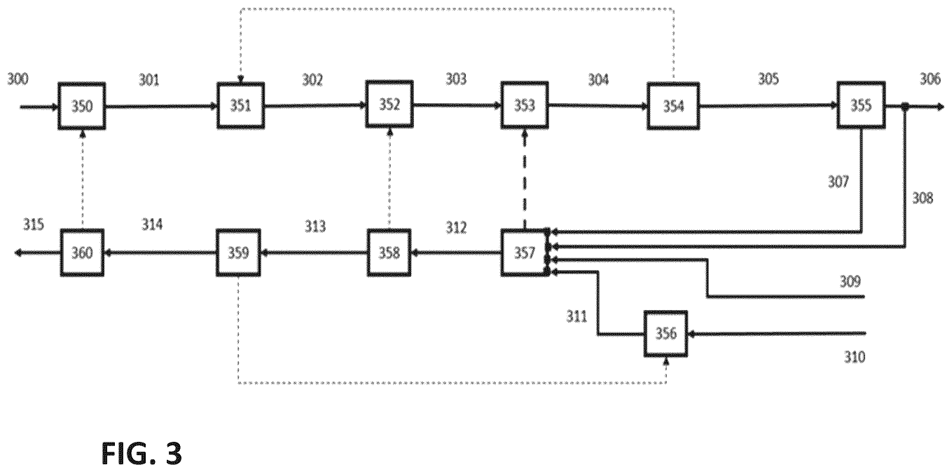

Assuming the NH₃ is produced in a carbon free or renewable way, it would be desirable to reduce the NH₃ consumption as much as possible. In Case 1c, an additional embodiment without a steam system is provided and illustrated in FIG. 3. The pre-heated process NH₃ 303 is cracked in the reactor 353. With no steam system in place, the heat available in the cracked process gas 304 is used to vaporize and pre-heat the NH₃ feedstock 301 in a heat exchange system 351/354, before being sent to the PSA 355. A combination of PSA off-gas 307, NH₃ fuel 309, combustion air 310, and optionally H₂ fuel 308 is burned in the furnace 357. Approximately 29.5% of the LHV is represented by NH₃ and approximately 70.5% by H₂.

This NH₃/H₂ mixture simplifies combustion due to the sufficiently high flame speed. In addition, the lower NH₃ level can lead to lower NOx levels if the combustion temperature is controlled well. The hot flue gas 312 first heats the NH₃ at the cracker inlet in heat exchanger 358/352, then it 313 exchanges heat with the combustion air in heat exchanger system 359/356. The residual low grade heat of the flue gas 314 is then used to vaporize the refrigerated NH₃ feedstock 300 in 360/350. This configuration produces no steam, but reduces the overall NH₃ consumption by 7.6% compared to Case 1a. Beyond a temperature of 530° C. on the hot combustion air 311, a change in materials grade is required. In order to achieve an efficient heat integration in the setup of Case 1c, the combustion air has been heated to 670° C.

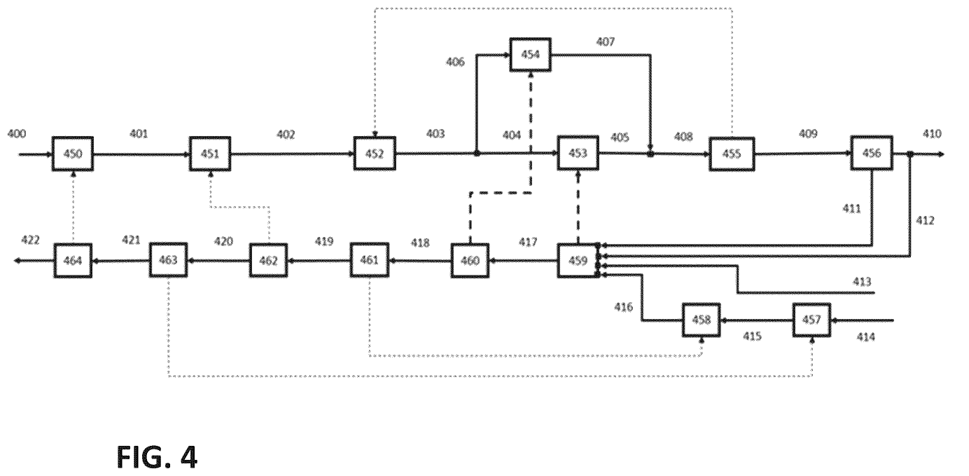

FIG. 4 provides a fourth embodiment, Case 1d, in which a gas heated cracker 454 is added in parallel to the main cracker 453, for which the heat is provided by the first heat exchanger 460 on the flue gas system downstream of the furnace 459. An additional heat exchanger 462/451 is used to vaporize the NH₃ feedstock, between the two heat exchangers 461/458, and 463/457, which heat the combustion air. In contrast to Case 1c, the hot combustion air T has been reduced to a more manageable 530° C.

Another alternative embodiment involves a cracker in a bayonet tube configuration, in which the cracked gas exchanges heat counter-currently with the reacting gas. The setup would then look similar to the one described in FIG. 3.

Another alternative embodiment is proposed in Case 1e, where the same configuration as Case 1c/FIG. 3 is used, but the cracking T is reduced to 550° C., and a portion of the pure H₂ stream downstream of the PSA is fed to the fuel system. In such a setup, a threshold T of 500° C. at the cracker inlet can be reached, which is preferable to ensure the NH₃ cracking reaction takes place from the onset of the catalyst, and the hot combustion air T does not exceed the threshold of 530° C. which might otherwise require a change in material grade. The advantage of this setup over Case 1d is that no gas heated cracker is required, and contrary to the alternative arrangement with a bayonet tube configuration which entails complications in the design of the cracker, a simple single pass tube design suffices in this case.

Table 1 below provides comparative data for the various embodiments described herein.

TABLE 1

| | | | | |
|---|---|---|---|---|
| | | | Case 1d - | |
| | | Case 1c - | NH3 cracker + | Case 1e - |
| | Case 1b - | NH3 cracker | GHC | NH3 cracker |
| Case 1a | NH3 cracker | T crack 600° C. - | T crack 600° C. - | T crack 550° C. - |
| NH3 cracking in an | T crack 600° C. - | no steam system - | no steam system - | no steam system - |
| existing SMR | E-F7 on flue | E-F7 on flue | E-F7 on flue | E-F7 on flue |
| T crack 600° C. | gas | gas | gas | gas |

Products/feedstock/fuel

| | | | | | |
|---|---|---|---|---|---|
| H2 prod (Nm3/h) | 100000 | 100000 | 100000 | 100000 | 100000 |
| Steam export (kg/h) | 28048 | 24189 | 0 | 0 | 0 |
| NH3 feed (kmol/h) | 3603 | 3603 | 3603 | 3590 | 3767 |
| NH3 fuel (kmol/h) | 456 | 356 | 148 | 159 | 0 |
| NH3 total (kmol/h) | 4059 | 3959 | 3751 | 3749 | 3767 |

Key process parameters

| | | | | | |
|---|---|---|---|---|---|
| T cracking (° C.) | 600 | 600 | 600 | 600 | 550 |
| dT-cracker (Bridge-wall | 150 | 150 | 150 | 150 | 150 |
| T - cracking T) | | | | | |
| % of LHV from NH3 in | 48.20% | 43.30% | 29.50% | 29.40% | 19.20% |
| fuel to furnace | | | | | |
| ηH2f - as defined | 15.00% | 15.00% | 15.00% | 15.00% | 17.30% |
| in (2) (in %) | | | | | |
| Cracker inlet T | 550 | 500 | 550 | 420 | 500 |
| (° C.) | | | | | |
| Hot combustion air T | 320 | 450 | 670 | 530 | 530 |
| (° C.) | | | | | |
| kg H2/kg NH3 | 0.129 | 0.132 | 0.140 | 0.140 | 0.139 |
| (feed + fuel) | | | | | |

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations that fall within the spirit and broad scope of the appended claims. The present invention may suitably comprise, consist or consist essentially of the elements disclosed and may be practiced in the absence of an element not disclosed. Furthermore, language referring to order, such as first and second, should be understood in an exemplary sense and not in a limiting sense. For example, it can be recognized by those skilled in the art that certain steps or devices can be combined into a single step/device.

The singular forms “a”, “an”, and “the” include plural referents, unless the context clearly dictates otherwise. The terms about/approximately a particular value include that particular value plus or minus 10%, unless the context clearly dictates otherwise.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations

1-13. (canceled)

14. A method for producing hydrogen using a feed stream comprising ammonia, the method comprising the steps of:
heating the feed stream in a first heat exchanger to produce a heated feed stream, wherein the heated feed stream is at a temperature above 500° C.;
introducing the heated feed stream into a first reaction zone under conditions effective for catalytically cracking the heated feed stream to produce a raw hydrogen stream, wherein the raw hydrogen stream comprises hydrogen and nitrogen;
cooling the raw hydrogen stream by indirect heat exchange against a first cooling fluid to form a cooled hydrogen stream; and
purifying the raw hydrogen stream to produce a hydrogen product stream and a tail gas, wherein the tail gas has a higher concentration of nitrogen as compared to the hydrogen product stream.

15. The method as claimed in claim 14, wherein the first reaction zone comprises reaction tubes filled with catalyst, wherein the catalyst are preferably selected from the group consisting of nickel, cobalt, ruthenium, rhodium, and combinations thereof.

16. The method as claimed in claim 14, wherein the raw hydrogen stream is at a temperature of at least 550° C. after leaving the first reaction zone.

17. The method as claimed in claim 14, wherein the feed stream is heated by indirect heat exchange in the first heat exchanger against a second cooling fluid, wherein the second cooling fluid is the raw hydrogen stream.

18. The method as claimed in claim 14, wherein the conditions effective for catalytically cracking the heated feed stream comprise a pressure between 20 and 35 bar (a) and providing heat to the first reaction zone via combustion burners that are fed with a fuel in the presence of an oxidizer, wherein the fuel comprises ammonia.

19. The method as claimed in claim 18, further comprising providing a second reaction zone in parallel with the first reaction zone, wherein the second reaction zone comprises a gas heated cracker that is heated by the flue gas.

20. The method as claimed in claim 19, wherein the second reaction zone is fed with a portion of the heated feed stream, wherein the portion is between 5% and 35% of the heated feed stream.

21. The method as claimed in claim 18, wherein the fuel has a lower heating value (LHV), wherein between 15-50% of the LHV is provided by ammonia, wherein between 50-85% of the LHV is provided by hydrogen.

22. The method as claimed in claim 18, wherein the tail gas, which is comprised of nitrogen, hydrogen, and unreacted ammonia, is fed with the fuel to the combustion burners, wherein a flue gas is produced by the combustion burners, the flue gas being substantially free of carbon dioxide, wherein the flue gas is preferably used to provide heating to a cold stream selected from the group consisting of the feed stream, the heated feed stream, water, the oxidizer, and combinations thereof.

23. The method as claimed in claim 14, wherein the raw hydrogen stream has a first hydrogen-component molar flow rate, and the sum of the hydrogen-component molar flow rates to the fuel define a second hydrogen-component molar flow rate, wherein a ratio of the second hydrogen-component molar flow rate to the first H₂-component molar flow rate (ηH2f) is in the range of 0.10-0.30.

24. The method as claimed in claim 14, wherein the first cooling fluid is water and an export steam stream is produced by said indirect heat exchange during the step of cooling the raw hydrogen stream, wherein the export steam stream flow rate compared to the second flow rate is preferably below 0.25 kg steam/Nm³ H₂.

25. The method as claimed in claim 14, wherein the heated feed stream is catalytically cracked in the presence of steam, wherein the steam is in an amount effective to reduce the formation of nitrides.

26. The method as claimed in claim 14, wherein the H₂ product forms a first mass flow rate, and a sum of the ammonia streams used for the feedstock and fuel form a second mass flow rate, wherein a ratio of the first mass flow rate to the second mass flow rate is at least 0.132.
